(19) United States
(12) Patent Application Publication
(10) Pub. No.: US 2009/0207194 A1
(43) Pub. Date: Aug. 20, 2009

(54) DRIVING METHOD

(75) Inventors: Po-Hsien Wang, Taichung City (TW); Chih-Chang Lai, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/388,473

(22) Filed: Feb. 18, 2009

(30) Foreign Application Priority Data
Feb. 19, 2008 (TW) 97105773

(51) Int. Cl. G09G 5/10

(52) U.S. Cl. 345/690

(57) ABSTRACT

A driving method adapted to driving an optical touch panel is provided. The optical touch panel is disposed on a backlight module and has a plurality of touch sensing elements. The touch sensing elements have a light-shading sensing mode and a light-reflecting sensing mode. The driving method includes sensing an intensity of an ambient light. When the intensity of the ambient light is greater than a reference, the touch sensing elements operate in the light-shading sensing mode. Alternately, when the intensity of the ambient light is smaller than the reference, the touch sensing elements operate in the light-reflecting sensing mode. The abovementioned driving method is help for the optical touch panel to accurately sensing in various conditions of different ambient lights such that the usage of the optical touch panel is more convenient.

### CROSS-REFERENCE TO RELATED APPLICATION

This application claims the priority benefit of Taiwan application serial no. 97105773, filed on Feb. 19, 2008. The entirety of the above-mentioned patent application is hereby incorporated by reference herein and made a part of specification.

### BACKGROUND OF THE INVENTION

1. Field of the Invention

The present invention generally relates to a driving method, in particular, to a driving method for an optical touch panel.

2. Description of Related Art

Currently, the touch panel and the display panel may be combined in two manners, namely a plug-in type and a built-in type. When the touch panel and the display panel are combined in the built-in manner, the volume of the electronic device is reduced, thus meeting the demands for thin volume. Therefore, the technique of the touch panel built in the display panel attracts more attention. FIG. 1 is a schematic cross-sectional view of a conventional optical touch panel built-in the display panel. Referring to FIG. 1, an optical touch panel 100 is disposed above a backlight module 102, and a plurality of optical touch sensing elements 104A, 104B, and 104C is disposed in the optical touch panel 100. When the user touches the optical touch panel 100 with a finger 106 or other object, the touch sensing elements 104A, 104B, and 104C may sense the change of the light and output a corresponding signal to execute various functions.

The touch sensing elements 104A, 104B, and 104C have two sensing modes, namely a light-shading sensing mode and a light-reflecting sensing mode. In the light-shading sensing mode, the touch of the finger 106 may shade the light above the touch sensing element 104B. Therefore, the touch sensing element 104B may output a corresponding signal to achieve a function of touch control. That is to say, in the light-shading sensing mode, the shading of the ambient light is sensed to perform the touch sensing. However, when the intensity of the ambient light is weaker, the ambient light sensed by each touch sensing elements 104A, 104B, and 104C is quite weak, such that the touch sensing elements 104A, 104B, and 104C cannot accurately distinguish the position touched by the finger 106.

For the light-reflecting sensing mode, when the finger 106 touches the optical touch panel 100, the light emitted by the backlight module 102 may be reflected back into the optical touch panel 100. At this time, the touch sensing element 104B can receive the reflected light to complete appropriate operating instructions. However, when the ambient light is intensive, all the touch sensing elements 104A, 104B, and 104C may receive the intensive light. Therefore, when the intensity of the ambient light is greater, the touch sensing elements 104A, 104B, and 104C cannot accurately distinguish the reflected light and the ambient light, and thus the reaction of the touch sensing elements 104A-C becomes blunt. On the whole, although the optical touch panel 100 is integrated with the display function of the display panel and has a more convenient operating mode, the optical touch panel 100 cannot be widely applied to various conditions of different ambient lights.

### SUMMARY OF THE INVENTION

Accordingly, the present invention is directed to a driving method, for solving the problem that the optical touch panel cannot be widely applied to various environments of different light intensities.

The present invention provides a driving method adapted to driving an optical touch panel. The optical touch panel is disposed on a backlight module and has a plurality of touch sensing elements. The touch sensing elements have a light-shading sensing mode and a light-reflecting sensing mode. The driving method includes sensing an intensity of an ambient light. When the intensity of the ambient light is greater than a reference, the touch sensing elements operate in the light-shading sensing mode. When the intensity of the ambient light is smaller than the reference, the touch sensing elements operate in the light-reflecting sensing mode.

In an embodiment of the present invention, when the touch sensing elements operate in the light-reflecting sensing mode, the method further includes improving a light emission intensity of the backlight module. In addition, when the touch sensing elements operate in the light-reflecting sensing mode, the method further includes improving a sensitivity of the touch sensing elements.

In an embodiment of the present invention, the optical touch panel further includes at least one ambient light sensing element, and the intensity of the ambient light is sensed by the ambient light sensing element.

The present invention further provides a driving method adapted to driving an optical touch panel. The optical touch panel is disposed on a backlight module and has a plurality of touch sensing elements. The driving method includes the following steps. The touch sensing elements operate in a light-reflecting sensing mode. Then, an intensity of an ambient light is sensed, and a sensitivity of the touch sensing elements is adjusted according to the intensity of the ambient light.

In an embodiment of the present invention, the driving method further includes adjusting a light emission intensity of the backlight module according to the intensity of the ambient light.

In an embodiment of the present invention, the optical touch panel further includes at least one ambient light sensing element, and the intensity of the ambient light is sensed by the ambient light sensing element.

The present invention further provides a driving method adapted to driving an optical touch panel. The optical touch panel is disposed on a backlight module and has a plurality of touch sensing elements. The driving method includes the following steps. The touch sensing elements operate in a light-reflecting sensing mode. Then, an intensity of an ambient light is sensed, and a light emission intensity of the backlight module is adjusted according to the intensity of the ambient light.

In an embodiment of the present invention, the optical touch panel further has at least one ambient light sensing element, and the intensity of the ambient light is sensed by the ambient light sensing element.

The optical touch panel of the present invention can implement different driving modes according to the intensity of the ambient light sensed by the light sensing elements. When the intensity of the ambient light is greater, the touch sensing elements operate in the light-shading sensing mode, and when the ambient light is weaker, the touch sensing elements operate in the light-reflecting sensing mode. When the touch sensing elements operate in the light-reflecting sensing mode, the driving method of the present invention can adjust the sensitivity of the touch sensing elements, and/or adjust the light emission brightness of the backlight module according to the intensity of the ambient light source, such that the touch sensing elements can accurately distinguish the position of the reflected light.

In order to the make aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a conventional optical touch panel built-in a display panel.

FIG. 2 is a schematic view of the optical touch panel according to an embodiment of the present invention.

FIG. 3 is a driving method for the optical touch panel according to an embodiment of the present invention.

FIGS. 4A and 4B are two driving methods for the optical touch panel according to another embodiment of the present invention.

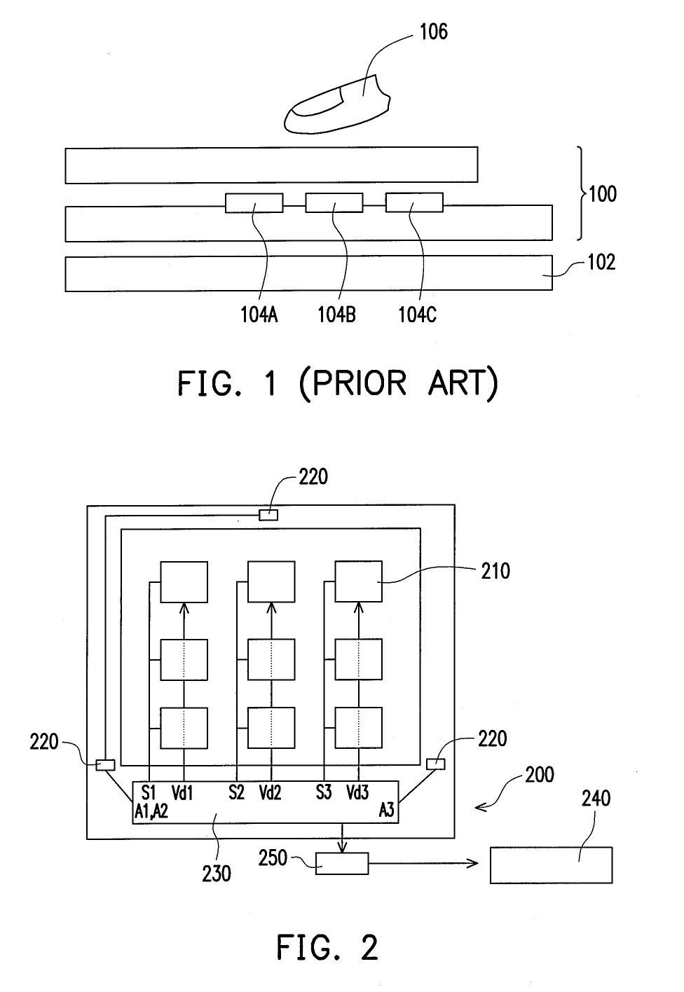

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

FIG. 2 is a schematic view of the optical touch panel according to an embodiment of the present invention. Referring to FIG. 2, an optical touch panel 200 has a plurality of touch sensing elements 210 and a plurality of ambient light sensing elements 220. The ambient light sensing elements 220 are used to sense the intensity of the ambient light, and the touch sensing elements 210 are used to sense the position touched by the user, so as to operate an electronic device having the same. The touch sensing elements 210 are for example built in a display panel. That is, the optical touch panel 200 is actually a touch display panel integrating a display function and a touch function or a touch panel having the display function. For example, the display panel is designed to be a thin film transistor liquid crystal display panel (TFT-LCD panel), then the touch sensing elements 210 may be disposed in a TFT array. In addition, the manufacturing process of the touch sensing elements 210 is compatible with the manufacturing process of the TFT. Definitely, the display panel may be other display panels, and the touch sensing elements 210 are built in the display panels, so as to form a touch panel having the display function.

In specific, the touch sensing elements 210 have two sensing modes, namely a light-shading sensing mode and a light-reflecting sensing mode. In the light-shading sensing mode, the touch sensing elements 210 are used to sense the position where the light is shaded so as to perform the touch control. In the light-reflecting sensing mode, the touch sensing elements 210 are used to sense the position of the reflected light so as to perform the touch control. In order to provide an appropriate light source to implement the light-reflecting sensing mode, in this embodiment, the optical touch panel 200 is disposed on a backlight module 240.

The ambient light sensing elements 220 are used to sense the ambient light, so as to switch the sensing modes of the touch sensing elements 210 according to the intensity of the ambient light. In this embodiment, for example, three ambient light sensing elements 220 are adopted, but the number is not limited thereto. In other optical touch panels 200, one or more ambient light sensing elements 220 may be used. In addition, it is acceptable that no ambient light sensing elements 220 are disposed on the optical touch panel 200, or the light sensing elements are attached externally at other positions independently.

The touch sensing elements 210 and the ambient light sensing elements 220 are connected to a sensing controller 230. The sensing controller 230 may switch the driving modes of the touch sensing elements 210 according to the signals output by the ambient light sensing elements 220. At this time, the sensing controller 230 may convert the signals output by the touch sensing elements 210 into various operating signals. Therefore, the optical touch panel 200 of this embodiment is applicable to various environments of different light intensities. In addition, a backlight controller 250 is further disposed between the sensing controller 230 and the backlight module 240, for adjusting the light emission intensity according to the intensity of the ambient light.

The sensing controller 230 may, for example, produce driving voltages Vd1-Vd3 to drive the touch sensing elements 210. The signals S1-S3 sensed by the touch sensing elements 210 may be transmitted to the sensing controller 230 to perform the operation of various instructions. In addition, the signals A1-A3 sensed by the ambient light sensing elements 220 may also be transmitted to the sensing controller 230, such that the sensing controller 230 switches the driving modes of the touch sensing elements 210 according to the signals A1-A3.

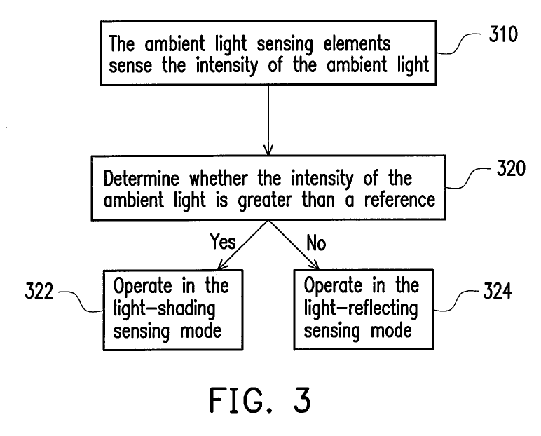

In detail, FIG. 3 shows the driving method of this embodiment. Referring to FIGS. 2 and 3, first, in step 310, the intensity of the ambient light is sensed by the ambient light sensing elements 220. The ambient light sensing elements 220 are, for example, disposed on periphery or out of the optical touch panel 200, so as to accurately sense the intensity of the ambient light. Certainly, the ambient light sensing elements 220 may be disposed on any other place of the touch panel 200.

Next, in step 320, the intensity of the ambient light is determined whether or not to be greater than a reference. The signals sensed by the ambient light sensing elements 220 may be transmitted to the sensing controller 230. At the same time, a chip on the sensing controller 230 may determine the signals of the ambient light. When the intensity of the ambient light is greater than the reference, the sensing controller 230 makes the touch sensing elements 210 to implement step 322, that is, to operate in the light-shading sensing mode. On the contrary, when the intensity of the ambient light is smaller than the reference, the sensing controller 230 makes the touch sensing elements 210 to operate in the light-reflecting sensing mode in step 324. Here, the reference is determined according to the design of the optical touch panel 200 and the design of the touch sensing elements 210. When the optical touch panel 200 is applied to a portable product or an outdoor device, the setting of the reference is different from the setting of the reference for the optical touch panel 200 applied to an indoor device. In addition, when the sizes, the element sensitivities, and other conditions of the touch sensing elements 210 are different, different references must be selected. In other words, the reference is determined according to the product usage, the element design, and other conditions.

When the intensity of the ambient light is adequate, the difference between light intensities of the shaded region where the user touches and other regions in the optical touch panel 200 is quite obvious. Therefore, the touch sensing elements 210 can accurately determine the position touched by the user through the light-shading sensing mode. When the intensity of the ambient light is inadequate, no matter the user touches the panel or not, the touch sensing elements 210 can merely sense the weak light. Thus, the light-shading sensing mode is not suitable, and the light-reflecting sensing mode must be used to perform sensing.

When the touch sensing elements 210 operate in the light-reflecting sensing mode, the light sensed by the touch sensing elements 210 is the sum of the two kinds of lights. One is the light formed after the ambient light passes through the optical touch panel 200, and the other is the light formed after the light provided by the backlight module 240 passes through the optical touch panel 200, reflected by the finger or a shading object and pass through the optical touch panel 200 once again. Therefore, the light emission intensity of the backlight module 240 may affect the intensity of the light sensed by the touch sensing elements 210 operating in the light-reflecting sensing mode. In other words, the backlight module 240 must provide a light with sufficient intensity to achieve that after passing through the optical touch panel 200 twice and being reflected once, the light can still be detected by the touch sensing elements 210.

In order to make the touch sensing elements 210 accurately distinguish the position touched by the user, in the light-reflecting sensing mode, the backlight controller 250 is further used to adjust the light emission brightness of the backlight module 240. The backlight controller 250 is connected between the backlight module 240 and the sensing controller 230, so the backlight controller 250 can adjust the light emission brightness of the backlight module 240 according to the intensity of the received ambient light. When the ambient light is quite weak, the touch sensing elements 210 can only sense the resultant light emitted by the backlight module 240 after passing through the panel twice and being reflected once. At this time, the backlight controller 250 can appropriately increase the light emission intensity of the backlight module 240, and thus the touch sensing elements 210 can accurately sense the position touched by the user.

Definitely, in this embodiment, the touch sensing elements 210 can perform accurate sensing under the weak ambient light in other manners, for example, adjusting the sensitivity of the touch sensing elements 210. In detail, when the sensing controller 230 senses a weak ambient light, the sensing controller 230 increase the sensitivity of the touch sensing elements 210. The sensitivity of the touch sensing elements 210 is, for example, related to the driving voltages Vd1-Vd3 of the touch sensing elements 210. If the driving voltages Vd1-Vd3 of the touch sensing elements 210 are higher, the sensitivity of the touch sensing elements 210 is more acute. In this embodiment, when the ambient light source is too weak, the sensing controller 230 may be used to raise the driving voltages Vd1-Vd3 of the touch sensing elements 210, and thus the touch sensing elements 210 can distinguish the weak light to perform the touch control.

In practice, in the light-reflecting sensing mode, the light emission brightness of the backlight module 240 and the sensitivity of the touch sensing elements 210 may be adjusted at the same time. On the whole, through the switching between the different operating modes and the adjustment of the above conditions, the optical touch panel 200 can provide appropriate sensing manners according to different intensities of the ambient light. Therefore, the optical touch panel 200 is applicable to various environments of different light intensities according to the driving method of this embodiment. Further, the driving method of this embodiment can improve the usage convenience of the optical touch panel 200.

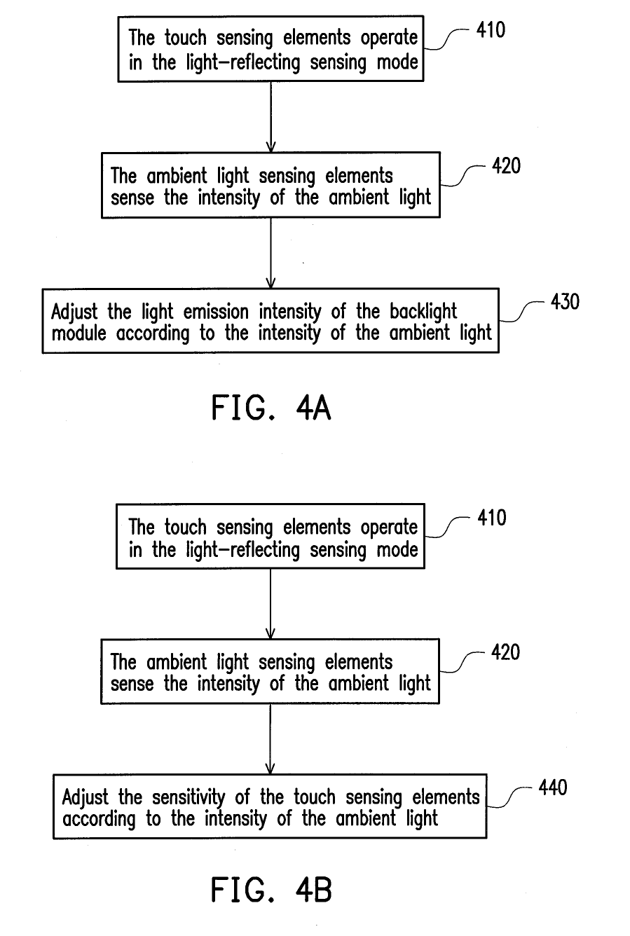

In addition, FIGS. 4A and 4B show two driving methods for the optical touch panel according to another embodiment of the present invention. Referring to FIGS. 2 and 4A, the driving method is used to drive the optical touch panel 200 as shown in FIG. 2. In this driving method, the touch sensing elements 210 operate in the light-reflecting sensing mode (step 410). Meanwhile, the intensity of the ambient light is sensed by the ambient light sensing elements 220 (step 420), and the light emission intensity of the backlight module 240 is adjusted according to the intensity of the ambient light (step 430).

When the intensity of the ambient light is weaker, the light received by the touch sensing elements 210 are not adequate to be sensed, so the backlight module 240 must provide sufficient light to make the intensity of the reflected light reaching above a lower detection limit of the touch sensing elements 210. Therefore, in the driving method of this embodiment, the optical touch panel 200 can operate normally in the dim environment by adjusting the brightness of the backlight module 240 according to the intensity of the ambient light.

The driving method as shown in FIG. 4B is approximately the same as the driving method as shown in FIG. 4A. The intensity of the ambient light sensed in step 420 of FIG. 4B is used as the reference for adjusting the sensitivity of the touch sensing elements 210 (step 440). When the intensity of the ambient light is weaker, in this embodiment, for example, the sensitivity of the touch sensing elements 210 is increased by raising the driving voltages Vd1-Vd3 of the touch sensing elements 210. In this manner, the optical touch panel 200 can accurately sense the position touched by the user without increasing the intensity of the ambient light and the reflected light. It is worth mentioning that the light emission intensity of the backlight module 240 in FIG. 4A and the sensitivity of the touch sensing elements 210 in FIG. 4B can also be adjusted at the same time, such that the optical touch panel 200 is applicable to different intensities of the ambient light.

To sum up, the driving method of the present invention switches the sensing modes of the touch sensing elements according to different intensities of the ambient light. Therefore, the inaccurate sensing or the loss of the sensing function of the optical touch panel will not occur under bright or dim ambient light. In addition, the driving method of the present invention further adjust the sensitivity of the touch sensing elements and the light emission intensity of the backlight module according to different intensities of the ambient light, so as to overcome the problem of the unsatisfactory reaction of the optical touch panel (the touched position cannot be accurately sensed) when the ambient light is inadequate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving method, adapted to driving an optical touch panel, wherein the optical touch panel is disposed on a backlight module and comprises a plurality of touch sensing elements, the touch sensing elements have a light-shading sensing mode and a light-reflecting sensing mode, the driving method comprising:
sensing a intensity of an ambient light; and
the touch sensing elements operating in the light-shading sensing mode when the intensity of the ambient light is greater than a reference, and operating in the light-reflecting sensing mode when the intensity of the ambient light is smaller than the reference.

2. The driving method according to claim 1, wherein when the touch sensing elements operate in the light-reflecting sensing mode, the method further comprises improving a light emission intensity of the backlight module.

3. The driving method according to claim 2, wherein when the touch sensing elements operate in the light-reflecting sensing mode, the method further comprises improving a sensitivity of the touch sensing elements.

4. The driving method according to claim 1, wherein when the touch sensing elements operate in the light-reflecting sensing mode, the method further comprises improving a sensitivity of the touch sensing elements.

5. The driving method according to claim 1, wherein the optical touch panel further comprises at least an ambient light sensing element, and the intensity of the ambient light is sensed by the ambient light sensing element.

6. A driving method, adapted to driving an optical touch panel, wherein the optical touch panel is disposed on a backlight module and comprises a plurality of touch sensing elements, the driving method comprising:
the touch sensing elements operating in a light-reflecting sensing mode;
sensing an intensity of an ambient light; and
adjusting a sensitivity of the touch sensing elements according to the intensity of the ambient light.

7. The driving method according to claim 6, further comprising adjusting a light emission intensity of the backlight module according to the intensity of the ambient light.

8. The driving method according to claim 6, wherein the optical touch panel further comprises at least an ambient light sensing element, and the intensity of the ambient light is sensed by the ambient light sensing element.

9. A driving method, adapted to driving an optical touch panel, wherein the optical touch panel is disposed on a backlight module and comprises a plurality of touch sensing elements, the driving method comprising:
the touch sensing elements operating in a light-reflecting sensing mode;
sensing an intensity of an ambient light; and
adjusting a light emission intensity of the backlight module according to the intensity of the ambient light.

10. The driving method according to claim 9, wherein the optical touch panel further comprises at least an ambient light sensing element, and the intensity of the ambient light is sensed by the ambient light sensing element.
